(19) United States
(12) Patent Application Publication
(10) Pub. No.: US 2024/0428009 A1
(43) Pub. Date: Dec. 26, 2024

(54) TRAINING A LOGICAL NEURAL NETWORK WITH A PRUNED LIST OF PREDICATES

(71) Applicant: International Business Machines Corporation, Armonk, NY (US)

(72) Inventors: Yeldar Toleubay, Tsukuba (JP); Don Joven Ravoy Agravante, Tokyo (JP); Daiki Kimura, Midori-ku (JP); Michiaki Tatsubori, Oiso (JP)

(21) Appl. No.: 18/214,377

(22) Filed: Jun. 26, 2023

(51) Int. Cl. G06F 40/40; G06F 40/205; G06F 40/30

(52) U.S. Cl. CPC G06F 40/40; G06F 40/205; G06F 40/30

(57) ABSTRACT

A computer-implemented method, according to one embodiment, includes extracting predicates from a predetermined plurality of sentences, and causing an explainer component to analyze the sentences to determine attentions from the predicates of the sentences. The method further includes causing the extracted predicates to be input into a predetermined pruner model. The pruner model is trained to use the attentions to generate a pruned list of predicates from the extracted predicates. A logical neural network is caused to be trained using the pruned list of predicates. A computer program product, according to another embodiment, includes a computer readable storage medium having program instructions embodied therewith. The program instructions are readable and/or executable by a computer to cause the computer to perform the foregoing method.

### BACKGROUND

The present invention relates to logical neural networks, and more specifically, this invention relates to training a logical neural network with a pruned list of predicates.

A logical neural network (LNN), which is a neuro-symbolic method, provides an explanation of outputs through a logical inference. The LNN is a recurrent neural network architecture in which neurons represent a precisely defined notion of weighted real-valued logic. LNNs typically include a 1-to-1 relationship to a system of logical formulae.

A predicate is the grammatical term for the words in a sentence or clause that describe the action, but not the subject. Predicates play a crucial role in LNN training and greatly affect the accuracy of the model. For example, in natural language applications, the training of a LNN may be accomplished through extraction of semantics of sentences through a semantic parser and further generation of the predicates and data samples for the sentences. All of the generated predicates and data samples are then used as input for training the LNN.

### SUMMARY

A computer-implemented method, according to one embodiment, includes extracting predicates from a predetermined plurality of sentences, and causing an explainer component to analyze the sentences to determine attentions from the predicates of the sentences. The method further includes causing the extracted predicates to be input into a predetermined pruner model. The pruner model is trained to use the attentions to generate a pruned list of predicates from the extracted predicates. A logical neural network is caused to be trained using the pruned list of predicates.

A computer program product, according to another embodiment, includes a computer readable storage medium having program instructions embodied therewith. The program instructions are readable and/or executable by a computer to cause the computer to perform the foregoing method.

A system, according to another embodiment, includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2A is a flowchart of a method, in accordance with one embodiment of the present invention.

FIG. 2B is a flowchart of sub-operations of an operation of FIG. 2A, in accordance with one embodiment of the present invention.

FIG. 3 is a table, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for training a logical neural network with a pruned list of predicates.

In one general embodiment, a computer-implemented method includes extracting predicates from a predetermined plurality of sentences, and causing an explainer component to analyze the sentences to determine attentions from the predicates of the sentences. The method further includes causing the extracted predicates to be input into a predetermined pruner model. The pruner model is trained to use the attentions to generate a pruned list of predicates from the extracted predicates. A logical neural network is caused to be trained using the pruned list of predicates.

In another general embodiment, a computer program product includes a computer readable storage medium having program instructions embodied therewith. The program instructions are readable and/or executable by a computer to cause the computer to perform the foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as predicate pruning code of block 150 for training a logical neural network with a pruned list of predicates. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

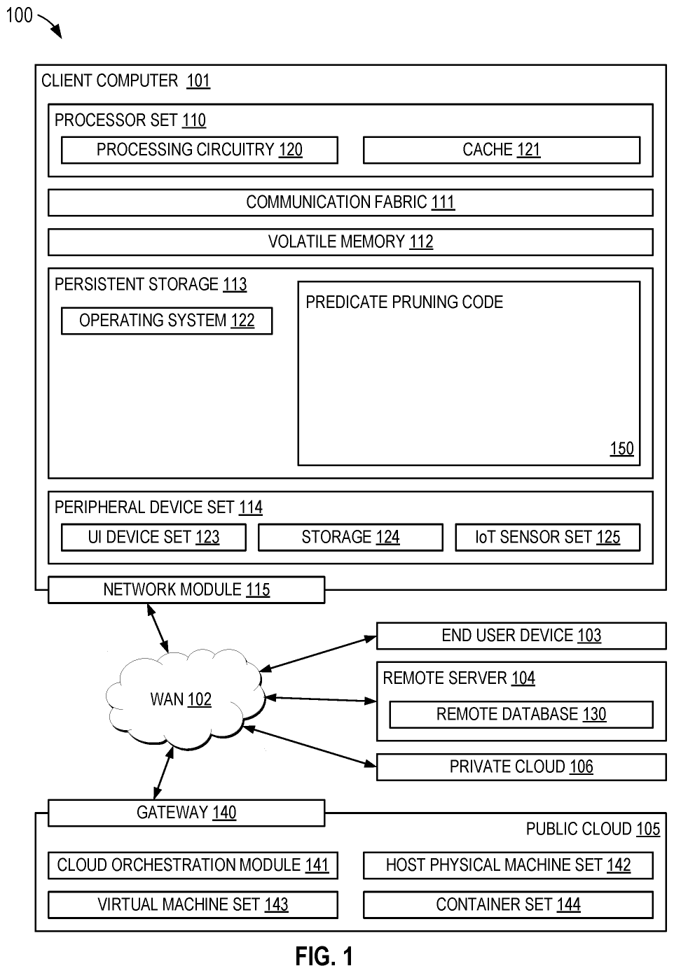

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, a logical neural network (LNN), which is a neuro-symbolic method, provides an explanation of outputs through a logical inference. The LNN is a recurrent neural network architecture in which neurons represent a precisely defined notion of weighted real-valued logic. LNNs typically include a 1-to-1 relationship to a system of logical formulae.

A predicate is the grammatical term for the words in a sentence or clause that describe the action, but not the subject. Predicates play a crucial role in LNN training and greatly affect the accuracy of the model. For example, in natural language applications, the training of a LNN may be accomplished through extraction of semantics of sentences through a semantic parser and further generation of the predicates and data samples for the sentences. All of the generated predicates and data samples are then used as input for training the LNN.

In the process of training a LNN, one issue is that for a linear increase in a number of predicates, the LNN requires an exponential increase in training time. This means that a training input that includes a relatively large number of predicates can cause a processing strain on the LNN and furthermore prolong the process of training the LNN. Conventional approaches do not include techniques for gauging and controlling a number of predicates that a training sample that is input into an LNN includes. This causes the training process of an LNN to strain processing resources of computing environments that include the LNN, with no way to predict or control when this occurs. Accordingly, there is a longstanding need within the technical field of LNN for predicate selection techniques to aid in a selection of predicates that are used for training an LNN. In sharp contrast to the deficiencies of the conventional approaches described above, the techniques of various embodiments and approaches described herein include LIME based predicate selection techniques which enable efficient training of LNNs by ensuring that training data includes only a controlled number of predicates. This enables reductions in training time for LNNs as compared to the conventional approaches described above and furthermore enables control over the model for pruning predicates determined to have relatively little impact in the training of the LNN.

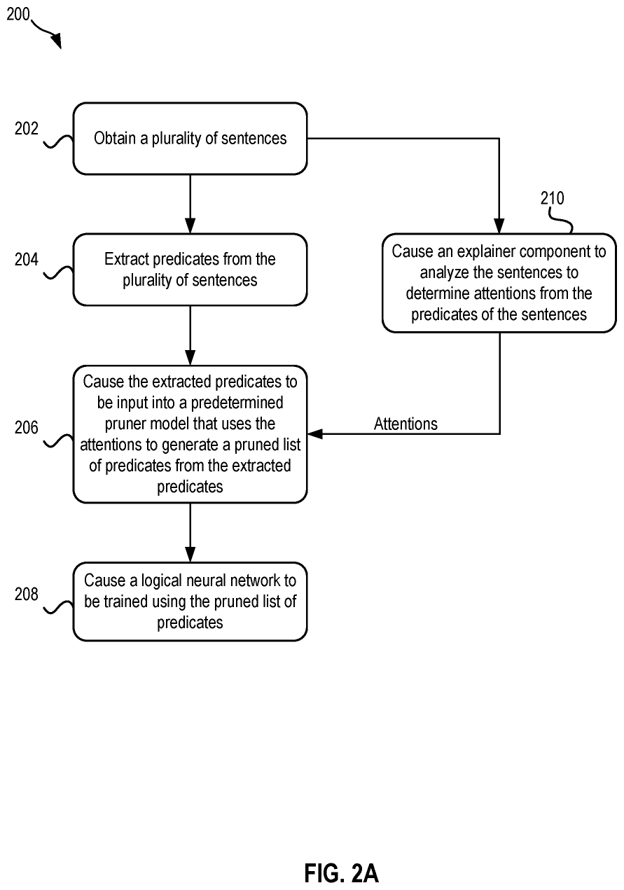

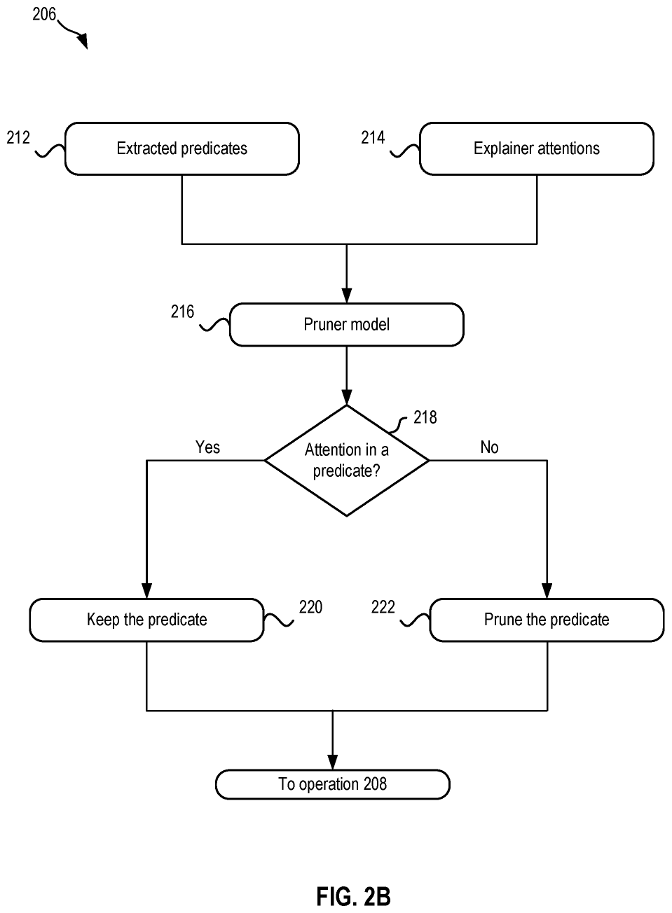

Now referring to FIG. 2A, a flowchart of a method 200 is shown according to one embodiment. The method 200 may be performed in accordance with the present invention in any of the environments depicted in FIGS. 1-4, among others, in various embodiments. Of course, more or fewer operations than those specifically described in FIG. 2A may be included in method 200, as would be understood by one of skill in the art upon reading the present descriptions.

Each of the steps of the method 200 may be performed by any suitable component of the operating environment. For example, in various embodiments, the method 200 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

Operation 202 includes obtaining a plurality of sentences to establish and use as a predetermined training dataset. In some approaches, the sentences are collected from a predetermined public domain, e.g., conversation boards, review forums for a product, a book, a chat log, etc. In some other approaches, the sentences are collected from a predetermined private domain.

It should be noted that, in embodiments and approaches described herein, any use of sentences that contain user data is preferably only obtained and used subsequent to a user granting permission for their data to be considered. More specifically, this permission is preferably obtained in such a way that the user has the opportunity to consider and review details of how their information will be used (to assist the user in making an informed decision), and thereafter presented with an option to opt-in, e.g., an expressly performed opt-in selection. Thereafter, the user is preferably reminded of their opt-in, and ongoingly presented with features, e.g., output for display on a user device associated with the user, that relatively easily allow the user to retract their previous election to opt-in.

In some approaches, the sentences are contiguous sentences in the domain that the sentences are collected from. For example, the sentences may be obtained from a predetermined portion of a document, in some approaches. In some other approaches, the sentences are non-contiguous sentences in the domain that the sentences are collected from. For example, within a document, a predetermined pattern may be used to determine the sentences, e.g., every other sentence, every fifth sentence, the first and last sentence of each paragraph, etc. For context, use of the predetermined pattern may break up relationships within the obtained sentences in order to generate a random and diversified sample of sentences for analyzing.

Predicates are extracted from the predetermined plurality of sentences, e.g., see operation 204. In some preferred approaches, extracting the predicates from the sentences includes applying an abstract meaning representation (AMR) parser to the sentences to extract semantics from the sentences. The AMR parser may be of a type that would become apparent to one of ordinary skill in the art after reading the descriptions herein. Extracting the predicates from the sentences may additionally and/or alternatively include converting the semantics into a graph. The predicates may, in some approaches, be determined from the graph. For example, in some approaches, nodes, e.g., keys, in the graph may represent concepts of the sentences, and edges, e.g., values, in the graph may represent relations to the concepts. The graph may be used to identify these concepts and edges, which may be used to distinguish and identify words in the sentences that are predicates and words in the sentences that are not predicates. In some approaches, sentence structure analysis techniques for using concepts and/or edges distinguish and identify words in the sentences that are predicates and words in the sentences that are not predicates, that would become apparent to one of ordinary skill in the art after reading the descriptions herein may be used.

It should be noted that otherwise using all of the determined predicates to train an LNN would be inefficient as such use does not control the number and/or type of predicates that would be applied to the training. For example, such an unrestricted application of all of the determined predicates of the sentences would otherwise result in extensive amounts of training time and at least some predicates likely being processed that have little to no training benefit. Accordingly, in order to relatively reduce training time of an LNN, various operations described below detail how at least some of the extracted predicates are pruned down to establish a relatively refined pruned list of predicates, where each of the predicates have relatively more training benefits than the predicates that are pruned from the refined pruned list of predicates.

In some approaches, the sentences are analyzed in order to determine predicates have relatively more training benefits for training an LNN. Operation 210 includes causing an explainer component, e.g., a trained module, to analyze the sentences to determine attentions from the predicates of the sentences. For context, an “attention” is a predicate that is determined to have relatively more training benefit potential than one or more other predicates, as will be described in greater detail elsewhere below. In some preferred approaches, the explainer component's analysis is not performed on the extracted predicates, but instead the raw, e.g., not already processed and broken down by analysis of the AMR parser, sentences of the predetermined plurality of sentences. In some other approaches, the explainer component's analysis is not performed on the extracted predicates from the plurality of sentences and/or the graph.

Local interpretable model-agnostic explanations (LIMEs) are, in some preferred approaches, used by the explainer component for analyzing the sentences. In some illustrative approaches, a plurality of predetermined operations are performed for analyzing the sentences to determine the attentions. For example, one or more of the predetermined operations may include inputting text of the sentences into the explainer component. The explainer component may be configured to and/or instructed to word-level tokenize the text (e.g., break down the words) to determine a plurality of tokens.

In one example, this tokenization may be performed for sentences that are online reviews for a given product. Words of one of such sentences of one of the reviews may attest that the product has a relatively “very cheap” cost and that the product is “very durable.” A LIME of the sentence may highlight words and/or strings of words that include the words “cheap” and “durable” as tokens and determine that these words (and from a relatively broader perspective at least a portion of the sentence that includes these words) attribute a relatively positive sentiment towards the product, e.g., the customer is satisfied with the product. In contrast, a LIME of the sentence may highlight words and/or strings of words that include the words “broke” and “disappointed” as tokens and determine that these words (and from a relatively broader perspective at least a portion of the sentence that includes these words) attribute a relatively negative sentiment towards the product, e.g., the customer is not satisfied with the product. In some approaches, these tokens may be tokenized and/or sorted subsequent to being tokenized, according to one or more predetermined classes of words and/or classes of predicates. For example, in the current approach, these tokens may be sorted into a predetermined class of words, e.g., reviews, positive reviews, relative durability, relative cost, etc. In some other approaches, the sentences are classified to the different classes and then at least some words of the sentences are tokenized.

In some approaches, the tokenization may separate words from their suffix. For example, for the extracted predicates that include the words “cheap”, “cheaper”, and “cheapest”, the word cheap may be tokenized to a first token, and the suffixes “er” and “est” may be tokenized to different tokens.

The determined tokens may, in some approaches, be fed separately into a predetermined predictor, e.g., such as a neural network and/or RandomForest of a type that would become apparent to one of ordinary skill in the art after reading the descriptions herein to make a probabilistic ranking of the words in terms of classification of a sentence, e.g., an utterance, to a predetermined class. For that purpose, first, a set of extracted AMR representations for the baseline model and original sentences are mapped together. Then a predictor such as a neural network or RandomForest is trained with sentences. In some experiments used to test the techniques described herein, LIME is used as explainer. The explainer is caused, e.g., instructed, to output “N” words which have relatively highest probabilities for the specified class as LIME attentions.

In some approaches, the LIME explainer is integrated with the neural network or RandomForest and works with raw sentences. Specifically, the explainer is caused to take text input and apply word-level tokenization. Then, each token is fed into NN or RandomForest separately, and words with the highest probabilities for each class are returned as LIME attentions. For example, in response to receiving the tokens, the neural network may be caused, e.g., instructed, to output the determined attentions from the sentences. In some preferred approaches, the attentions are words of the sentences. Furthermore, the attentions are, in some of such approaches, determined, e.g., by the predetermined neural network, to have at least a predetermined probability for increasing an accuracy of the LNN during the training of the LNN. These probabilities are, in some approaches, based on predetermined classes of words. In one of such approaches, each of the attentions is based on a different predetermined class of words with respect to the other attentions. For example, the neural network may be caused, e.g., instructed, to determine, for each of the predetermined classes, words with relatively highest probabilities for being associated with the class. According to a more specific example, assuming that a predetermined class is based on durability of a product, and assuming that tokens that are based on the words “strong” “unbreakable” and “sour”, the neural network may be caused, e.g., instructed, to determine which of the three words has the relatively highest probability for being associated with the “durability” class. During such analysis, the neural network may determine that the token “sour” does not relate to the durability of a product, and therefore the token “sour” may be assigned a weight associated with a relatively lowest probability for being associated with the class. Furthermore, during such analysis, the neural network may determine that the token “unbreakable” relates relatively more to the durability of a product than the token “strong”, and in response to such a determination, the token “unbreakable” may be assigned a relatively greater weight than the weight assigned to the token “strong”. In this example, because the token “unbreakable” is assigned a relatively strongest weight, the token “unbreakable” is determined to have the relatively highest probability for being associated with the “durability” class, and based on having the relatively highest probability, the token “unbreakable” is set as the attention of the “durability” class.

Mapped AMR representations are compared with LIME attentions, and representations that do not contain LIME attentions values are pruned. More specifically, the extracted predicates are caused, e.g., instructed, to be input into a predetermined pruner model, e.g., see operation 206. The pruner model is, in some preferred approaches, trained to use the attentions to generate a pruned list of predicates from the extracted predicates. In some preferred approaches, using the attentions to generate the pruned list of predicates from the extracted predicates includes comparing mapped abstract meaning representations (AMRs) to the attentions. Accordingly, an output of the explainer component that includes the determined attentions may additionally and/or alternatively be input into the pruner model, e.g., see “Attentions” logical path of operation 210. During the comparison of the mapped abstract meaning representations (AMRs) to the attentions, the extracted predicates of AMRs that are determined to not contain, e.g., are determined to not match, at least one of the attentions are not included in the pruned list of predicates. More specifically, in some approaches, the pruner model is instructed to compare mapped AMR representations with LIME attentions, and representations that are determined to not contain at least a predetermined threshold degree of similarity with at least one of the LIME attentions are pruned. In contrast, during the comparison of the mapped abstract meaning representations (AMRs) to the attentions, the extracted predicates of AMRs that are determined to contain, e.g., are determined to match, at least one of the attentions are included in the pruned list of predicates. Techniques for determining and comparing a degree of similarity with a predetermined threshold, that would become apparent to one of ordinary skill in the art after reading the descriptions herein, may be used.

Looking to FIG. 2B, exemplary sub-operations of causing the extracted predicates to be input into the predetermined pruner model are illustrated in accordance with one embodiment, one or more of which may be used to perform operation 206 of FIG. 2A. However, it should be noted that the sub-operations of FIG. 2B are illustrated in accordance with one embodiment which is in no way intended to limit the invention.

Sub-operation 212 includes inputting extracted predicates into a predetermined pruner model. Explainer attentions may additionally and/or alternatively be input into the pruner model, e.g., see sub-operation 214. The pruner model may be caused, e.g., instructed, to use the attentions to generate a pruned list of predicates from the extracted predicates. For example, sub-operation 216 includes causing, e.g., instructing the pruner model to compare the attentions with the extracted predicates. Based on the comparison, a determination may be made as to whether any of the attentions exist in, e.g., match, one of the extracted predicates, e.g., see sub-operation 218. It should be noted that although the flowchart of FIG. 2B describes a matching condition determination, as described elsewhere above, in some other approaches, a predetermined threshold degree of similarity condition may additionally and/or alternatively be applied to determine whether to keep or prune a predicate.

In response to a determination that a match does exist, e.g., as illustrated by the “Yes” logical path of sub-operation 218, the predicate is kept and added to a pruned list of predicates, e.g., see sub-operation 220. In contrast, in response to a determination that a match does not exist, e.g., as illustrated by the “No” logical path of sub-operation 218, the predicate is pruned and not added to the pruned list of predicates, e.g., see sub-operation 222.

With reference again to FIG. 2A, the pruned list of predicates is used to train a predetermined LNN. The LNN is preferably trained to correctly identify, e.g., predict, predicate states. For example, in continuation of the example above, the trained LNN is able to use the positive LIME sentiments to identify positive reviews in a collection of sentences, and use the negative LIME sentiments to identify negative reviews in the collection of sentences. More specifically, in some approaches, the LNN is additionally and/or alternatively trained to identify classes that the words of a given one of the sentences correspond to. In some approaches, a predetermined LNN is caused, e.g., instructed, to be trained using the pruned list of predicates and the predicates that are pruned from the extracted predicates to thereby not be included in the pruned list of predicates are not used to train the LNN, e.g., see operation 208. The LNN is preferably a type of neural network that can be configured to learn logical rules. The learning follows that of known neural networks in that backpropagation and gradient descent may, in some approaches, be used to learn network weights. However, in contrast to contemporary neural networks which typically require the specification of highly specific architectures, e.g., such as convolutional neural networks, recurrent neural networks, fully-connected neural networks, etc., the architecture of the LNN described herein is preferably specified using logical formulas. In some approaches, a logical formula is specified before the learning procedure. In some implementations, the “logical AND gate” configuration may be chosen, in which case the inputs and outputs of the LNN follows a logical conjunction operator. This means that, in some approaches, the output value of the network is “TRUE” only when all the input values are also “TRUE”. Moreover, the LNN may be implemented with real-valued logic, e.g., inputs and outputs are allowed a real value anywhere between 0.0 and 1.0, as opposed to the binary nature of classical logic where inputs and outputs can only be either 0 or 1. In some preferred approaches, the inputs of the LNN correspond to the predicates of the sentences and the output corresponds to the membership of a certain class defined by the classification task. A single LNN logical “AND gate” may be created and used for each of these classes. In some approaches, in the case of mutually exclusive classes, additional gates, e.g., exclusive logical “OR gate”, may be added to the architecture, e.g., an additional gate for each mutually exclusive class of the classes of words.

During evaluation, the LNN is preferably trained and/or caused to output a real-valued logic. For example, the LNN may be instructed to determine that even states that are only approximately true to be “TRUE”. That is, all values between 0.5 and 1.0 are determined to be “TRUE” for evaluation purpose. The converse is also the case in that all values between 0.0 and 0.5 are determined to be “FALSE”.

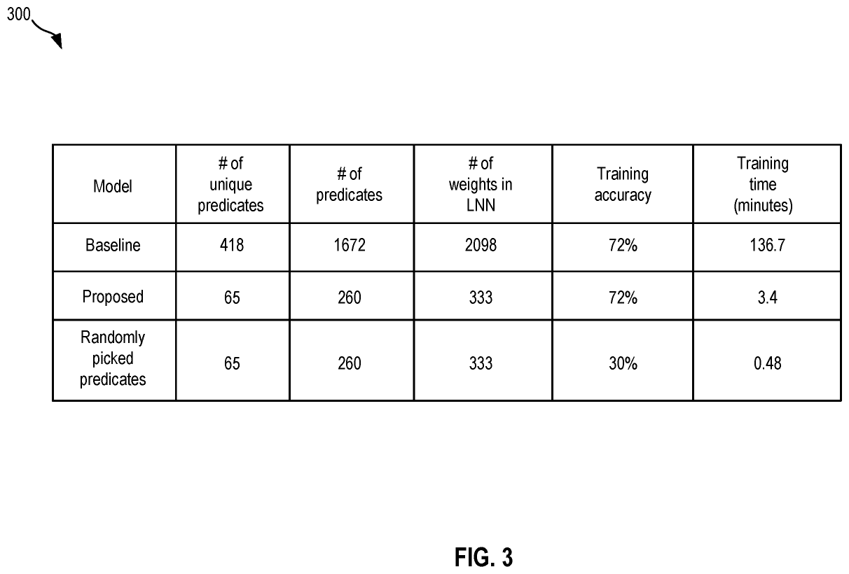

Several performance benefits are enabled as a result of using the pruned list of predicates to train the LNN as opposed to using all of the extracted predicates to train the LNN. For example, by using a relatively refined, e.g., pruned, list of predicates to train the LNN, relatively fewer processing operations are performed to train the LNN. It should be noted however, that the accuracy of the LNN is not compromised as a result of pruning at least some predicates from the pruned list of predicates. Note that in some preferred approaches, the accuracy is determined and equal to a ratio of the number of correctly classified predicate states over a total number of predicate states. This is because, without pruning the predicates using the techniques described herein, an unrestricted application of all of the predicates of the sentences of a training set of data would otherwise result in at least some predicates likely being processed that have little to no training benefit. Specifically, these predicates likely being processed that have little to no training benefit are the predicates that do not satisfy attention conditions and are therefore pruned out using the techniques described herein. Accordingly, the techniques described herein reduce training time of LNNs and reduce an amount of processing that training LNNs takes, without compromising the accuracy of the trained LNN. It should be noted that these performance benefits are described in greater detail elsewhere herein, e.g., see FIGS. 3-4 which detail actual experimental training results.

In one illustrative use case, a collection of customer reviews may be used for creating a predetermined plurality of sentences of a predetermined training dataset. The customer reviews may be obtained from a fully anonymized online forum that allows customers to post reviews based on verified purchases that they have made. In some approaches, transcripts of four types of reviews may be used, which include, e.g., relatively positive reviews, relatively extremely positive reviews, relatively neutral reviews, and relatively low reviews. In some experiments, a “transcript” may be a full review by a customer about a product, while a “sentence” represents a full response of a customer to a specific question about the product. In some approaches, the LNN may require a special dataset structure to function. Accordingly, using the techniques described herein, AMR representations may be converted into predicates and samples, where each AMR key represents a predicate, and all values of the AMR representations generate samples. A sample contains all predicates that have been mined from the predetermined dataset and the corresponding output of a parser as groundings. Values of the groundings may be assigned according to the presence of the predicate-sample pair in the parsed sentence for each class. This means only predicate-sample pairs that result from that sentence assigned with TRUE grounding for that sample may be used to train the LNN.

FIG. 3 depicts a table 300, in accordance with one embodiment. As an option, the present table 300 may be implemented in conjunction with features from any other embodiment listed herein, such as those described with reference to the other FIGS. Of course, however, such a table 300 and others presented herein may be used in various applications and/or in permutations which may or may not be specifically described in the illustrative embodiments listed herein. Further, the table 300 presented herein may be used in any desired environment.

Table 300 illustrates experimental results of using predicates to train three different LNN models. A first LNN model, e.g., see “Baseline”, is trained using all of the predicates extracted from a plurality of sentences of a predetermined training dataset. In contrast, a second LNN model is trained using a pruned list of predicates that is determined using the techniques described herein, e.g., see method 200. A third LNN model, e.g., see “Randomly picked predicates”, is trained using a plurality of randomly picked predicates of the plurality of sentences.

It should be noted that the first LNN model is trained using 1672 extracted predicates, while the second LNN model is trained using a pruned list of 260 predicates. While an accuracy of the first LNN model and the second LNN model is the same, e.g., see 72%, training of the first LNN model takes 40.2 times more training time, e.g., see 3.4 minutes to train the second LNN model and 136.7 minutes to train the first LNN model. These results demonstrate the extensive reductions in time that implementing the techniques described herein enable. Furthermore, it may be noted that although the third LNN model is able to be trained relatively fastest, e.g., see 0.48 minutes, the training accuracy that results in using randomly picked predicates to train the third LNN model significantly underperforms when compared to the training accuracy of the second LNN model. Specifically, in the case of the randomly picked predicates, the third LNN model has less than half of the accuracy of the second LNN model. These results demonstrate the extensive reductions in accuracy that implementing the random predicate selection techniques cause as compared to using the techniques described herein for determining a pruned list of predicates for training the second LNN model.

Scalability of an LNN is an issue that requires selection of the “right” predicates, e.g., predicates that improve an accuracy of the LNN model during training. The techniques described herein provide an explainer based predicate selection and pruning mechanism for natural language applications. The proposed techniques use a trained neural network and/or machine learning model on a specified task and extracts explainer attentions. The extracted attentions are compared with AMR representation values, and representations that are determined to not contain any LIME attentions are pruned.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
extracting predicates from a predetermined plurality of sentences;
causing an explainer component to analyze the sentences to determine attentions from the predicates of the sentences;
causing the extracted predicates to be input into a predetermined pruner model, wherein the pruner model is trained to use the attentions to generate a pruned list of predicates from the extracted predicates; and
causing a logical neural network to be trained using the pruned list of predicates.

2. The computer-implemented method of claim 1, wherein extracting the predicates from the sentences includes: applying an abstract meaning representation (AMR) parser to the sentences to extract semantics from the sentences, and converting the semantics into a graph, wherein the predicates are determined from the graph.

3. The computer-implemented method of claim 2, wherein nodes in the graph represent concepts of the sentences, wherein edges in the graph represent relations to the concepts.

4. The computer-implemented method of claim 1, wherein local interpretable model-agnostic explanations (LIMEs) are used by the explainer component for analyzing the sentences.

5. The computer-implemented method of claim 1, wherein analyzing the sentences to determine the attentions includes:
inputting text of the sentences into the explainer component,
tokenizing the text to determine a plurality of tokens,
feeding the plurality of tokens separately into a predetermined neural network, and
wherein an output of the neural network includes the determined attentions from the sentences.

6. The computer-implemented method of claim 5, wherein the attentions are words of the sentences, wherein the attentions are determined to have at least a predetermined probability for increasing an accuracy of the logical neural network during the training of the logical neural network.

7. The computer-implemented method of claim 6, wherein each of the attentions is based on a different predetermined class of words.

8. The computer-implemented method of claim 7, wherein an architecture of the logical neural network includes a different logical AND gate for each of the different classes of words, and an exclusive logical OR gate for each mutually exclusive class of the classes of words.

9. The computer-implemented method of claim 1, wherein using the attentions to generate the pruned list of predicates from the extracted predicates includes comparing mapped abstract meaning representations (AMRs) to the attentions, wherein the extracted predicates of AMRs that are determined to not contain at least one of the attentions are not included in the pruned list of predicates.

10. A computer program product, the computer program product comprising a computer readable storage medium having program instructions embodied therewith, the program instructions readable and/or executable by a computer to cause the computer to:
extract predicates from a predetermined plurality of sentences;
cause an explainer component to analyze the sentences to determine attentions from the predicates of the sentences;
cause the extracted predicates to be input into a predetermined pruner model, wherein the pruner model is trained to use the attentions to generate a pruned list of predicates from the extracted predicates; and
cause a logical neural network to be trained using the pruned list of predicates.

11. The computer program product of claim 10, wherein extracting the predicates from the sentences includes: applying an abstract meaning representation (AMR) parser to the sentences to extract semantics from the sentences, and converting the semantics into a graph, wherein the predicates are determined from the graph.

12. The computer program product of claim 11, wherein nodes in the graph represent concepts of the sentences, wherein edges in the graph represent relations to the concepts.

13. The computer program product of claim 10, wherein local interpretable model-agnostic explanations (LIMEs) are used by the explainer component for analyzing the sentences.

14. The computer program product of claim 10, wherein analyzing the sentences to determine the attentions includes:
inputting text of the sentences into the explainer component,
tokenizing the text to determine a plurality of tokens,
feeding the plurality of tokens separately into a predetermined neural network, and
wherein an output of the neural network includes the determined attentions from the sentences.

15. The computer program product of claim 14, wherein the attentions are words of the sentences, wherein the attentions are determined to have at least a predetermined probability for increasing an accuracy of the logical neural network during the training of the logical neural network.

16. The computer program product of claim 15, wherein each of the attentions is based on a different predetermined class of words.

17. The computer program product of claim 16, wherein an architecture of the logical neural network includes a different logical AND gate for each of the different classes of words, and an exclusive logical OR gate for each mutually exclusive class of the classes of words.

18. The computer program product of claim 10, wherein using the attentions to generate the pruned list of predicates from the extracted predicates includes comparing mapped abstract meaning representations (AMRs) to the attentions, wherein the extracted predicates of AMRs that are determined to not contain at least one of the attentions are not included in the pruned list of predicates.

19. A system, comprising:
a processor; and
logic integrated with the processor, executable by the processor, or integrated with and executable by the processor, the logic being configured to:
extract predicates from a predetermined plurality of sentences;
cause an explainer component to analyze the sentences to determine attentions from the predicates of the sentences;
cause the extracted predicates to be input into a predetermined pruner model, wherein the pruner model is trained to use the attentions to generate a pruned list of predicates from the extracted predicates; and
cause a logical neural network to be trained using the pruned list of predicates.

20. The system of claim 19, wherein extracting the predicates from the sentences includes: applying an abstract meaning representation (AMR) parser to the sentences to extract semantics from the sentences, and converting the semantics into a graph, wherein the predicates are determined from the graph.
